(19) United States
(12) Patent Application Publication
(10) Pub. No.: US 2016/0242580 A1
(43) Pub. Date: Aug. 25, 2016

(54) Anti-Wrinkle Fabric Arrangement

(71) Applicants: Stan Batiste, Granite Bay, CA (US); Maryanne Batiste, Granite Bay, CA (US)

(72) Inventors: Stan Batiste, Granite Bay, CA (US); Maryanne Batiste, Granite Bay, CA (US)

(21) Appl. No.: 15/047,330

(22) Filed: Feb. 18, 2016

Related U.S. Application Data
(63) Continuation-in-part of application No. 14/599,384, filed on Jan. 16, 2015.
Application No. 14/599,384 is a continuation of application No. 13/372,378, filed on Feb. 13, 2012, now Pat. No. 8,978,178.
(60) Provisional application No. 62/117,908, filed on Feb. 18, 2015.
(60) Provisional application No. 61/463,084, filed on Feb. 11, 2011.

(51) Int. Cl. A47G 9/02; B32B 27/36; B32B 5/18; B32B 5/02

(52) U.S. Cl. CPC A47G 9/0253; B32B 5/02; B32B 27/36; B32B 5/18; B32B 2317/10; B32B 2262/08; B32B 2535/00; B32B 2437/00; B32B 2307/746; B32B 2307/304; B32B 2307/51

(57) ABSTRACT

A fabric arrangement is designed to prevent skin lines, wrinkle formation, or other skin damage while improving sleep using combinations of fabrics, cooling technologies and scents. The fabric arrangement is designed with a specific fabric and material combination that create a surface in which the shear stresses causing skin lines, wrinkles, and other skin damage are eliminated. Multiple layers making up the fabric arrangement include a top layer comprising a stretchable material and a second layer comprising a low friction material relative to the top layer. Supporting the first two layer is a support layer such as foam. Lower layers may comprise a cooling material, an antimicrobial or anti-allergenic material and a scent layer.

### CROSS REFERENCE TO RELATED APPLICATIONS

This application claims priority to U.S. Provisional Application No. 62/117,908 which was filed on Feb. 18, 2015. This application further claims priority as a continuation-in-part application to U.S. patent application Ser. No. 14/599,384 which was filed on Jan. 16, 2015, which a continuation application of U.S. patent application Ser. No. 13/372,378 (now patented as U.S. Pat. No. 8,978,178) which was filed Feb. 13, 2012, which application claims priority to U.S. Provisional Application No. 61/463,084, which was filed on Feb. 11, 2011. The contents of the above listed applications are incorporated by reference.

### BACKGROUND

1. Field of Invention

The present invention relates to fabric arrangement and in particular to a method and apparatus for reducing wrinkles and skin tension.

2. Description of Related Art

Wrinkles are typically associated with old age and an un-youthful appearance. As a result, people often try to reduce the appearance of skin wrinkles and often take steps to reduce the creation of wrinkles.

Numerous different approaches have been proposed in the past to reduce or eliminate wrinkles. This approach typically focuses on the face and neck and may take the form of a pillow, which supports the face and neck during sleep. The approaches may be classified into physical, medical, or chemical in nature. One prior art approach is in the form of a contour type pillow which is designed to keep the skin off the surface of the pillow. This approach suffers from the inherent difficulty in attempting to keep a user's skin off the pillow and the discomfort that causes the user, which may interrupt normal sleep patterns.

Another approach is set forth in U.S. Pat. No. 5,084,928 titled Pillowcase Formed of Elastic Fabric. This prior art approach simply provides an elastic pillowcase into which the pillow is compressed. This pillow compressed inside the pillowcase in combination with the elastic pillowcase is proposed to be made so taut that it will not wrinkle, and hence will not transfer wrinkles to the user of the pillow. This approach suffers from the drawback of changing the hardness and density of the pillow itself, which causes the pillow to become significantly more firm. Hence, the pillow may provide too much support to the user. In addition, the pillow still wrinkles when the weight of the user's head compresses the pillow and elastic material.

A third approach prevent wrinkles involves use of cloth fabric as the pillow covering with a high number of threads per inch. The asserted benefit to using a high thread count fabric is that such fabric decreases the loss of moisture and provides a smooth surface for the skin. Finally, chemical based approaches include designs which use copper imbedded into the material of the pillow. The copper is asserted to help prevent wrinkles by reducing bacterial buildup in the pillow due to the copper's ability to reduce bacteria. The reduced bacterial level is asserted to reduce damage to the skin and thereby also reduce wrinkles. However, Both of these proposed wrinkle reduction method suffer from drawbacks. The use of high thread count sheets create more expensive and delicate product, while the use of copper is not only expensive, but can be washed away during laundering.

The innovation described below, overcomes the drawbacks associated with the prior art and provides additional benefits.

### SUMMARY

Disclosed herein is a fabric arrangement for a pillow, a blanket, clothing, or the like having specific features that prevent skin lines and wrinkle formation, that protect the skin from bed sores, and that prevent damage to healing skin tissue. The fabric arrangement further improves sleep using combinations of fabrics, cooling technologies and scents. For example, the disclosed fabric arrangement allows the user to sleep in a normal fashion using what feels like their normal pillow instead of other anti-wrinkle pillow designs which generally use various shapes to keep the skin away from the pillow surface.

As we age, the appearance of sleep wrinkles, those facial lines that develop from sleeping with your face against a pillow, becomes much more prominent. This should come as no surprise if one considers how much of one's life is spent sleeping. If you are getting the recommended 8 hours of sleep per night, you sleep ⅓ of your life. Consequently, by age 60, you will have slept 20 years. It is obvious why sleeping on our face eventually leads to creases that become permanently etched in the surface of the skin. As we age, when the skin becomes creased while sleeping, it no longer is able to readily snap back when the head is not resting on the pillow, as it did when we were younger. Sleep wrinkles are much easier to prevent than they are to repair.

The sleep lines referred to herein are initially temporary creases in the skin that when a person is young disappear after a few minutes to within hours of waking up. Sleep lines are a result of shear stresses and direct forces acting on the skin from long term contact from a pillow. When young, the skin has the elasticity that can withstand these pressures. As people age, their skin becomes less resilient and these lines become permanent wrinkles, continually increasing in number, length and depth.

According to the numerous dermatologists, wrinkles are a result of both internal forces created from physiologic changes in the skin and external forces such as pressure on the skin surface and environmental factors such as the sun. The three major forces that are responsible for sleep lines are shear stress, direct pressure, and pressures exerted on the bunching of materials and their related forces.

Sleep lines caused by shear stress are a result of parallel differential motion of your skin relative to the pillow. As a person moves, their skin moves over the pillow fabric surface and as a result, friction and associated shear stress is created. The shear stress stops a region of the skin from moving and it then bunches up and forms creases.

The sleep line has a second component which is the force created by the weight of the head acting in a perpendicular direction to the shear stress. This force then acts upon the sleep line by increasing the pressure and further deforming the skin.

The final factor causing the creation of sleep lines is that of material bunching and pressure. When you look at most pillows there are fabric wrinkles that naturally occur due to excess materials. As a person sleeps they move and this creates waves of material that can “bunch-up” under their skin. This bunched-up material with the exerted pressures of your head result in sleep lines.

These same forces are also at play affecting certain patients in hospitals. For example, a patient who recently underwent surgery may have healing incisions resulting from the surgery. As a person moves around on the bed, such incisions may be damaged by the shear stresses described above. This may also be true for patients in burn units or who are suffering from other skin-related ailments. In other scenarios, the above described forces may contribute to bed sores resulting from situations where a patient must spend a long time laying down on a bed. Thus the embodiments described herein may have practical application across a spectrum of material that come into contact with a person's skin.

### Stretchable Layer and Sheer Stress

Systems and method for counteracting the forces of sheer and direct pressure through skin contact with a pillow, sheet, or other fabric are disclosed herein. To eliminate sheer, a solution may include using stretchable materials that do not allow the build-up of “parallel” pressures. As the skin contacts the stretchable material, the pressures that would normally be created and maintained are released due to the material stretching. Therefore, as skinfolds are developing, the energy is dissipated and the skin lies flat.

Essentially, as the skin moves the fabric arrangement (or at least the top layer) stretches and moves with the skin to eliminate sleep lines. The forces on a person's skin from a standard pillow increase rapidly, beyond the limit for the skin to crease. The fabric arrangement disclosed herein stretches and keeps the stress low and below the level required to create skin creasing.

### Elastic Layer, Sheer Stress and Direct Pressure

A second feature of the stretchable material is that as the direct pressure from the weight of the head or body is applied to the pillow, a constant positive sheer force is created that works to keep the skin tight. The more direct (perpendicular) force there is, the greater the positive shear becomes to keep the skin tight and free of wrinkles and creases.

### Slip Layer

Although the stretchable materials are helpful, it was found during materials testing that a second “Slip Layer” provided even greater benefit. Embodiments disclosed herein may include a second layer with a slippery surface allowing the stretchable material to slide thereon to significantly improve the function of the elastic or stretchable top layer function.

### Bunching Effect

A third feature of the design disclosed herein is that it overcomes material “bunching” associated with normal pillows. Bunching is reduced or eliminated as the stretchable material is always taut on the pillow. A user's head then always rests on a pillow without material waves or wrinkles. In a standard pillow the weight of a person's head can be exposed to this “bunching” of materials for hours. With the fabric arrangement formed as a pillow case, a person's head always rest on a smooth soft surface.

The disclosed embodiments relate to a pillow or other items coming into contact with the skin that are designed to prevent skin lines and wrinkle formation while improving sleep using combinations of fabrics, cooling technologies, and scents. The disclosed embodiments are designed with a specific fabric and material combinations that create a surface in which the shear stresses causing skin lines and wrinkles are eliminated. Beneath the anti-wrinkle fabric combination may be a layer of foam, fabric, or any other material to create a support layer for the material which also has anti-microbial properties. A third or fourth layer may be composed of a cooling agent to keep the skin cool preventing damage and the phenomena of puffy eyes and swelling.

The disclosed embodiments may include a scent holder which allows various scents to be placed for aroma therapy while sleeping. The embodiments overcome the limitations of the prior inventors by specific material combinations and scents that will improve sleep, prevent wrinkles and skin lines, decreases eye swelling and facial bloating while allowing the user to sleep with a standard, normal feeling pillow.

In an example embodiment, a fabric arrangement is provided that comprises at least a first panel and a second panel forming an interior space configured to accept a pillow such that the first panel and the second panel are configured to form a pillow case. Also part of this embodiment is that the first panel and/or the second panel comprise from the outer most layer inward a first layer comprising an elastic fabric and a second layer having a first side and a second side. The first side of the second layer is adjacent to the first layer and comprises a low friction surface. The first layer and the second layer may be joined at the edges and may comprise the same general size. A third layer may be provided and comprises a support layer configured to support the first layer and the second layer.

In one embodiment, the fabric arrangement further comprises a fourth layer, the fourth layer comprising a cooling material configured to absorb heat from the first through the third layers. In one configuration, the cooling material comprises one or more of the following materials: sodium phosphate salt, sodium ammonium phosphate salt, or ammonium phosphate salt. In on embodiment, the fabric arrangement further comprises a fifth layer, the fifth layer comprising an antimicrobial element configured to inhibit growth of bacteria and microbes. A scent pocket configured to hold a scent infused element may also be part of this fabric arrangement. The third layer may also comprise an antimicrobial, and the elastic fabric may be configured to be capable of stretching in any direction.

Also disclosed herein is a fabric arrangement for bedding configured to reduce the formation of wrinkles in a user's skin comprising a first layer having a top surface and a bottom surface the first layer comprising an elastic material configured to stretch in at least two directions and contact the user's skin with the top surface. A second layer is provided that has a top surface and a bottom surface such that the second layer top surface is configured to contact the bottom surface of the first layer and provide a low friction interface between the first layer bottom surface and the second layer top surface. In this embodiment a third layer is provided and configured to contact the second layer bottom surface such that the third layer comprises a support layer for the first layer and the second layer.

In one embodiment the interface between the first layer and the second layer establishes a lower coefficient of friction there between as compared to a coefficient of friction between the first layer and the skin of the user. The bedding may include sheets, pillows, blankets, pillow cases, and pillow covers. In one configuration the first layer is stretchable in 360 degrees of motion parallel to the second surface layer. In one embodiment the fabric arrangement further comprises a fourth layer comprising a pouch and a cooling layer such that the pouch is configured to contain the cooling layer and the cooling layer comprising a liquid or gel configured to conduct heat away from the skin of the user.

In one configuration the fabric is an anti-wrinkle panel for use in a pillow case such that the panel that is part of the pillow case comprises two layers. The first layer comprises a stretchable and low friction layer and it is configured as the outer layer to contact the skin of a user. The second layer below is below the first layer and it comprises a low friction layer such that the coefficient of friction between the first layer and the second layer is less than 0.3. Finally a support layer is presented under the first layer and the second layer. The support layer is configured to support the first layer and second layer and the support layer further comprises a heat conducting element as part of the support layer that conducts heat away from the first layer and second layer.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 illustrates an exemplary pillow having a pillow case formed form a fabric arrangement shown and described herein.

FIG. 2 illustrates the fabric arrangement as an inset or sub-portion to a pillow case top side.

FIG. 3 illustrates one example arrangement of the fabric layers that comprises the fabric arrangement shown and disclosed herein.

FIG. 4 illustrates an optional inner fabric pouch configured to hold a scent element.

FIG. 5A and FIG. 5B illustrate a cooling material layer packaged either in a single container or with multiple small pockets.

FIG. 6 illustrates a pillow with an example fabric arrangement according to another exemplary embodiment.

FIG. 7 illustrate layers in the pillow shown in FIG. 6.

FIG. 8A and FIG. 8B illustrate a fabric arrangement with one or more spaces therebetween, according to exemplary embodiments.

FIG. 9 illustrates an exemplary fabric arrangement on an article of clothing according to an exemplary embodiment.

FIG. 10 illustrates an exemplary fabric arrangement on a bandage, according to an exemplary embodiment.

FIG. 11A and FIG. 11B illustrate exemplary insulated fabric arrangement according to exemplary embodiments.

### DETAILED DESCRIPTION OF EMBODIMENTS

In general, the embodiments disclosed herein employ several layers of materials, referred to herein as a fabric arrangement, configured such that when contacting the skin of the user will reduce or prevent the formation of wrinkles in the skin of the user. This fabric arrangement may be applied to or made to cover any item that touches the skin. For example, the fabric arrangement may be configured as a pillow or pillow cover, but as described below, the fabric arrangement may be used in other environments. In other embodiments, additional elements may be combined with the fabric arrangement to provide additional benefits.

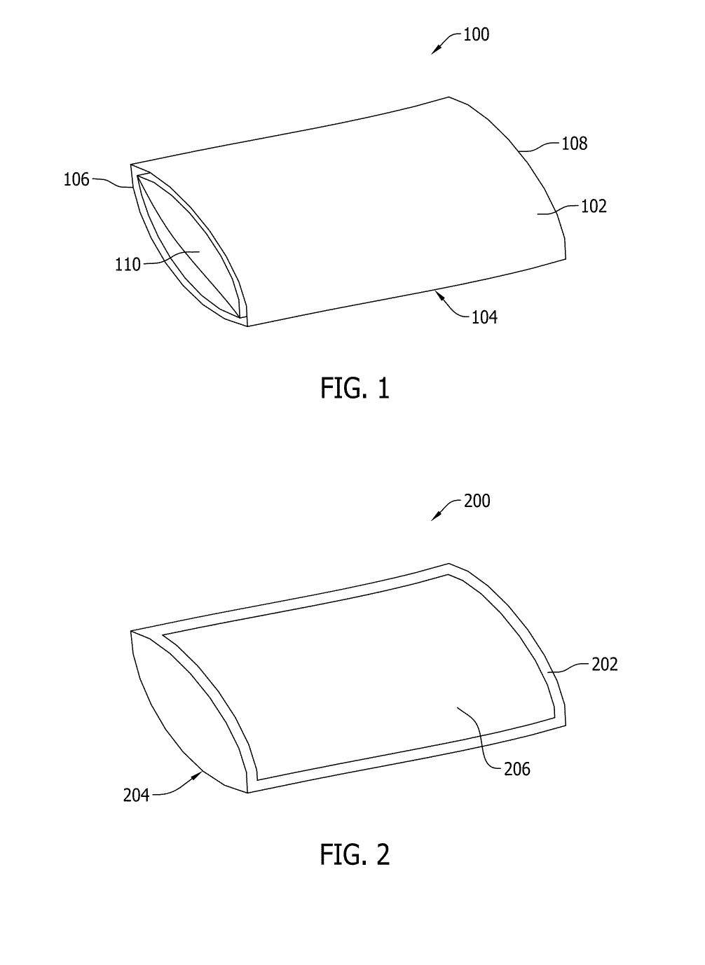

FIG. 1 illustrates an example environment of use for the fabric arrangement as set forth herein. In this embodiment, the fabric arrangement is included as part of, or is made in the form of a standard pillowcase. As shown in FIG. 1, a general pillow case 100 comprises two separate panels with a bottom side 104 and a top side 102 of fabric which are attached permanently on three sides forming an open first end 106 and a closed second end 108. The open end 106 may thus accept the insertion of a pillow 110. The open end 106 may be left open or may be closed using means such as buttons, zippers, snaps, or any other closure device or system after the insertion of the pillow 110. The two fabric panels 102, 104 can be made similar or can be made out of two or more materials composed of various textures for comfort, durability, or aesthetics. The top side 102 may be different than the bottom side 104. The panels 102, 104 may be attached by sowing, gluing, or any other closure means.

In one embodiment shown in FIG. 2, the general configuration is that of a pillow case 200 with standard cloth on the bottom side 204 that employs specific design on the top side 202 using several layers of fabric to create the fabric arrangement. As shown in FIG. 2, the fabric arrangement may be an insert 206 or sub-portion to the top side 202 of the pillow case 200 for the specific area that will contact the skin of the user.

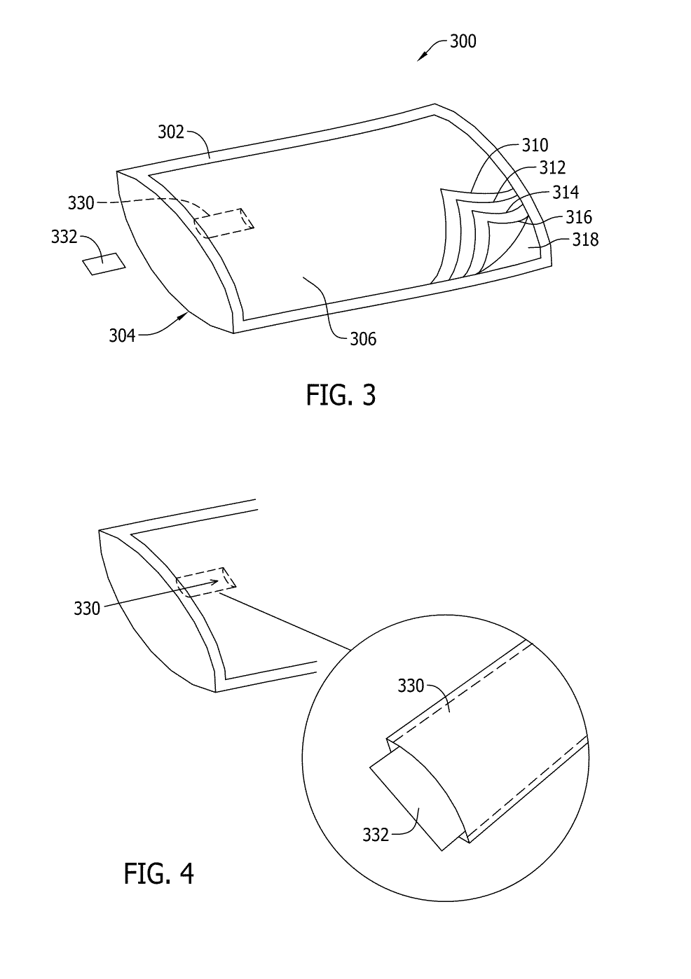

Turning now to FIG. 3, one example arrangement of fabric layers is shown and disclosed. This is one example arrangement that may comprise the fabric arrangement, such as in area 206 shown in FIG. 2. In this description, the layers within the fabric area 306 are defined in order from the outermost layer to the innermost layer. The outermost later in this embodiment is a stretchable fabric 310 on the top surface 302 of the pillowcase 300. The stretchable fabric 310 may comprise a fabric that stretches in one, two, or all directions along the layer of fabric. In one embodiment the material is a 360 degree stretchable fabric. The stretchable fabric may comprise, but is not limited to spandex, knit fabric with elastic yarns, nylon, fabric blends, any combination of these materials, or any other material capable of stretching in more than one direction.

One preferred material for the stretchable fabric is spandex or a fabric containing spandex fibers in the fabric. Spandex is beneficial for a number of reasons. First, it can be stretched repeatedly and return almost exactly back to the original size and shape. Second, spandex is lightweight, soft, and smooth. Additionally, spandex is easily dyed. Spandex is also resilient since it is resistant to abrasion and the deleterious effects of body oils, perspiration, and detergents. Spandex is compatible with other materials, and can be spun with other types of fibers to produce unique fabrics, which have characteristics of both fibers. Spandex is an elastomer, thereby allowing it to be stretched to a certain degree in all directions and it recoils to its original shape when released. These fibers are superior to rubber because they are stronger, lighter, and more versatile. In some configurations, spandex fibers can be stretched to almost 500% of their length.

Spandex is sold by numerous companies under numerous different brand names including Lycra (made by Invista, previously a part of DuPont), Elaspan (also Invista's), Creora (Hyosung), ROICA and Dorlastan (Asahi Kasei), Linel (Fillattice), and ESPA (Toyobo).

Spandex is lightweight and does not restrict movement and is already used in used in athletic wear, thereby providing a comfort level among users. The form-fitting properties of spandex make it a good selection for the stretchable layer of the fabric arrangement described herein.

In the case of Style 480 spandex available from Cooper Fabrics, the machine direction M is the same as the direction of the greatest stretch of the fabric. In particular, the coefficient of friction of the Style 480 spandex at two-ply intersections or an equivalent intersection has been found to be static, dry, and about 0.25 or lower. Spandex has excellent elasticity, with the ability to stretch 270 percent or greater in the M direction and 90 percent or greater in the direction orthogonal to the M direction.

It is also contemplated that a knit fabric having knit-in elastic yarns and substantially balanced stretch characteristics may be used as the stretchable fabric. The knit may be made in the in the walewise and coursewise directions as is understood in the art of making such a fabric. The fabric can be tricot knit to include knit in elastic yarns, and forms an oscillating cable pattern in the walewise direction. Such a fabric would have good stretch characteristics in both the coursewise and walewise directions, with the stretch in the walewise direction being substantially the same as that in the coursewise direction.

In one embodiment, the stretchable fabric 310 is any material that when minimal force is applied in any direction the length changes and when the force is released the material regains its original shape. This is commonly seen in synthetic fabrics, however many types of materials can be used for this purpose. The ability of the materials to stretch in any direction allows it to release any type of sheer stress that would be imparted on it. This feature therefore will not allow the human skin to build up shear stress and thus wrinkles cannot form. With facial motion during sleep, stress which normally would be imparted on the skin creating wrinkle and skin lines will not be created and the skin can relax to its normal smooth and flat configuration.

Below the stretchable fabric 310 is a generally smooth, low friction material or low friction fabric layer 312. The low friction material 312 has at least a top surface which has low friction relative to the stretchable fabric 310, thereby allowing the stretchable fabric 310 to easily slide on top of the low friction material 312 so as not to bind against the low friction material 312. Hence, the low friction material 312 provides a surface for the two layers to slide smoothly over each other, allowing the stretchable fabric 310 to perform maximally. The low friction material 312 may comprise, but is not limited to a medium to high thread count polyester material, a polyester, a polyester crepe back satin, a silk, a nylon, a Teflon, a rayon, or any other low friction material.

In one embodiment, the coefficient of friction between the elastic layer and the low friction layer is between 0.5 and 0.3. In another embodiment, the coefficient of friction between the elastic layer and the low friction layer is between 0.3 and 0.2. In one embodiment, the coefficient of friction between the elastic layer and the low friction layer is 0.25 or lower. In one embodiment, the coefficient of friction between the elastic layer and the low friction layer is 0.15 or less. In one configuration, the first layer and the second layer are different materials.

In one configuration, the stretchable fabric 310 is the same size or dimension as the low friction material layer 312. Movement between the stretchable fabric 310 and the low friction material layer 312 is a result of the stretchable nature of the stretchable fabric 310 and the low friction layer 312 below the stretchable fabric 310. Having the two layers 310, 312 being generally the same size provides a benefit of inhibiting or preventing the top layer 310 from bunching up or overlapping when in use, which would indent, crease, and wrinkle the user's skin.

In one embodiment, the layers 310, 312 are only attached at the edges such as by sewing, with thread, gluing, or heat welding. This allows the inner areas of the fabric arrangement 306 when configured in a pillow arrangement to freely slide and move with the user's skin, which reduces indents, creases, and wrinkles in the skin. This provides a benefit over prior art that attaches the layer near the center or where the skin contacts.

Also disclosed herein is a configuration where both the stretchable fabric 310 and the low friction material layer 312 are both low friction materials on either one side or both sides. As can be appreciated, when both layers 310, 312 are low friction in nature, it is less likely that the skin will bind, wrinkle, and crease on the top layer 310. This arrangement further increases smooth sliding of the top layer 310 over the second layer 312. Prior designs made of cotton suffer from the drawback of not stretching and do not easily slide across one another. In addition, two slip layers provide additional slippage which reduces wrinkles.

Some prior art approaches promote having the upper layer materials as being very tight to prevent creasing and bunching, but these prior art references fail to appreciate or consider the sheer stresses on the skin as the person moves. Other prior art system only consider low friction materials which do not allow adequate shear stress dissipation. These sheer stresses can cause wrinkles. A shear stress is defined as the component of stress coplanar with a material cross section. Shear stress arises from the force vector component parallel to the cross section. Normal stress, on the other hand, arises from the force vector component perpendicular to the material cross section on which it acts. The design disclosed herein appreciates the interaction of the two materials (top two layers which slide relative to each other) which do not allow shear stresses to develop between the skin and the fabric while preventing bunching of those materials.

Below the low friction fabric 312 is a support layer 314. The support layer 314 may be optional and may comprise foam, fabric, or any other material configured to support the low friction layer and provide a degree of support properties. In one embodiment, the support layer 314 comprises an antimicrobial. In one embodiment, the support layer 314 comprises an anti-allergen. In one embodiment, the support layer 314 comprises both an anti-allergen and an antimicrobial.

In one configuration, the support layer 314 is designed with closed cell, thin, antimicrobial foam or anti-allergen material to provide a backing for layers 310 and 312. By its added density, the foam 314 further improves the function of the stretchable fabric 310 by acting as a backing force. This support layer 314 also employs antimicrobial properties enhancing the property of skin protection and long term wrinkle prevention. A third function of the support layer 314 is to provide a layer of material between the user and the cooling material 318 in the event the cooling material makes noise when moved, or is hard or irregular when in the pillow case 300.

The support layer 314 may be removable to allow replacement or additional material to be added to refresh the support layer 314. The support layer 314 may be optional. The support layer 314 may comprise, but is not limited to, foam, fabric, thin polymer, or other synthetic materials.

Below the support layer 314 is a pouch 316 formed of a thin material configured to form the pouch. The pouch 316 is sized to contain or hold a cooling material 318. The pouch 316 may be formed from any type material as would be understood by one of ordinary skill in the art. The cooling material 318 is configured as a layer of material or fabric configured to serve as a heat sink to transfer heat away from the skin of the user to thereby reduce heat buildup that occurs when a user's skin contacts a pillow for an extended period of time. As can be appreciated, heat buildup in the skin and tissue may lead to sweating, swelling, or other undesirable effects that may puff or wrinkle the skin. The cooling layer 316, 318 and the support layer 314 may be combined into a single layer.

The cooling layers 316, 318 provide a layer of material to reduce or eliminate that heat buildup and the associated unwanted affects. The cooling material 318 may be composed of an endothermic cooling material, water in either liquid or ice form, or other cooling gels or agents.

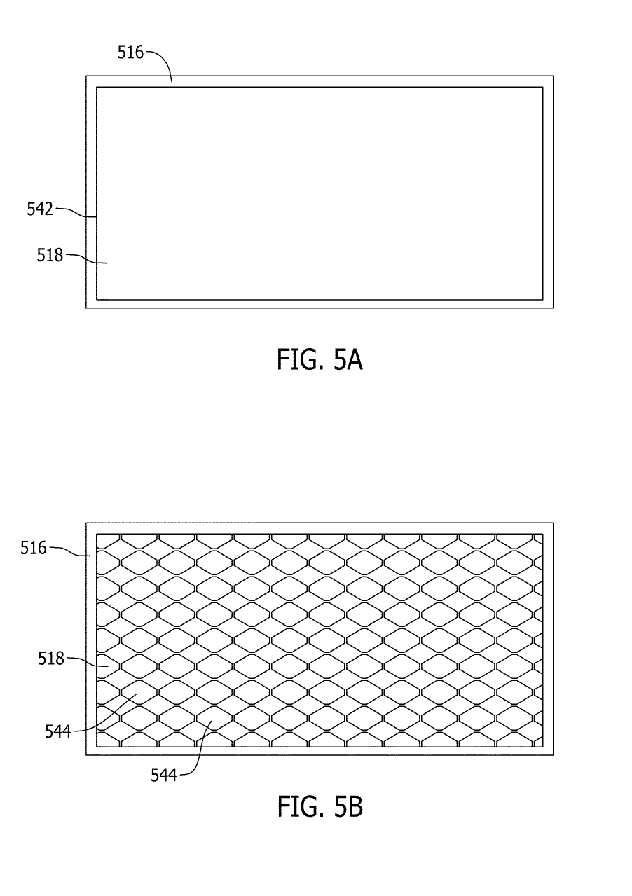

An example of the cooling layers is shown in FIGS. 5A and 5B. Here, the cooling material 518 may be packaged within the pouch 516 in either a single container 542 or with multiple small pockets 544. The cooling material 518 may be permanently sealed or re-fillable with material. In one embodiment, the cooling material 518 is removable and reusable. In one embodiment, the material is removable and may be placed in a refrigerator or freezer to further enhance its cooling properties. In one embodiment, the cooling material is a heat conducting material with good thermal conductive properties to thereby transfer heat away from the user's skin.

In one embodiment, the cooling material 518 comprises a temperature regulating membrane called Outlast made by or available from Gateway Technologies that can be inserted between any of the layers of the fabric arrangement 306. Alternatively, a cooling material 518 available from Frisby Technologies can be embedded in the foam layer 314. The foam may comprise open cell flexible polyester hydrophilic foam. In one configuration the hydrophilic foam is AQUAZONE or VPF brand material, but may also or alternatively be a Frisby product called COMFORTEMP, or the like.

It is also contemplated that the cooling material 518 may comprise a membrane or coating that can be placed on one or more sides of the foam 314 and/or on the top layer 310 or any other layer to conduct heat away from the user's skin. It is contemplated that if phase change technology from Outlast, Frisby, Freudenberg, Schoeller or Invista, or the like us used, it may be combined with any foam, nonwoven or insulative layer and can be on either or both sides of any layer.

It is also contemplated that the cooling material 518 may be fibers and fabrics with reversible enhanced thermal properties, respectively which may be available from Triangle Research & Development Corp., Gateway Technologies, or Frisby. Incorporated by reference in their entirety are U.S. Pat. Nos. 4,756,958 and 5,366,801 which are directed to fibers and fabrics with reversible enhanced thermal properties. Other patents assigned to Triangle Research & Development Corp., that are related by cooling material fiber and fabric include U.S. Pat. Nos. 5,415,222; 5,290,904; and 5,244,356 which are also incorporated herein by reference in their entirety.

In addition, U.S. Pat. No. 5,499,460 is directed to a moldable foam insole with reversible enhanced thermal storage properties and this material can serve as the cooling material 518. The disclosure of this patent is hereby incorporated by reference, and is illustrative of one type of moldable than that can be used as mentioned herein.

Returning to FIG. 3, one embodiment may include an optional inner most fabric formed into a small pouch 330 for a scent element 332 placement. FIG. 4 illustrates a magnified view of the pouch 330 and scent element 332. The scent pocket 330 is created within the inner portion of the pillow case 300. A scent element 332 is created by imbedded or applied solutions with scents placed prior to inserting into the pillow case 300. The scent element 332 is inserted into the created small pouch 330. In various embodiments, the scent element 332 may comprise scented paper, herbs, salts, foams, fabric, cotton, or encapsulated beads or pellets.

When formed as a pillow case 100, 200, 300, a standard pillow 110 (FIG. 1) may be inserted, and the unit is ready for use. In other embodiments, the pillow 110 may be sealed inside the fabric arrangement.

In alternative embodiments, the fabric arrangement is provided in other environments besides a pillow case. As mentioned above the fabric arrangement may be built into a pillow itself such that the pillow is self-contained within the fabric arrangement. In addition, the entire pillow case or pillow may be made of or surrounded by the fabric arrangement.

It is contemplated, although not required that the pillow case made from the fabric arrangement or made from a portion of the fabric is configured as generally the same size as the pillow which is placed inside the pillow case. This provides a benefit over pillow cases which are smaller than the pillow. Pillow cases which are smaller than the pillow distort the shape of the pillow and require the user to forcefully stuff the pillow into the reduced size pillow case. This prior art arrangement also makes the pillow more firm since it is compressed into a small pillow case. This changes the entire dynamic of the pillow which can cause stiffness in the neck or un-restful sleep. In addition, when the stretchable layer is in its neutral position when the user places their head on the pillow, this is less wrinkle causing than if the stretchable layer is already stretched by the compressed pillow because the stretchable layer has more capability to stretch or move with the skin than if it were pre-stretched fabric, which is in essence, not stretchable any further. The pre-stretching by the compressed pillow case takes all the stretch ability from the fabric.

In operation, the user would present the cooling layer into the pouch and then provide a pillow into the pillow case that is configured with the fabric arrangement describe herein. A user would then lay their face or head on the fabric arrangement as part of the pillow case and sleep in the normal manner. During sleep, as the user moves, the user's skin may attempt to crease or wrinkle as it moves in relation to the pillow.

With prior art pillows the pillow itself would wrinkle as the user's skin compressed the pillow or moved against the pillow. When the pillow wrinkled and creased, the user skin would likewise form into a wrinkle and could be maintained in this position for the entire evening. This also stretches the skin which leads to a loss of skin elasticity.

Using a pillow having the fabric arrangement described herein, as the user's skin moves, the top layer stretches with the moving skin, thereby preventing a crease or wrinkle from forming in either the top layer of the fabric or the user's skin. The low friction layer beneath the stretchable layer allows the stretchable layer to easily expand and contract with the movement of user by eliminating or reducing friction. As the user continues to move, the stretchable fabric moves and contracts with the user movements and skin to maintain the user's skin in smooth configuration.

The cooling element reduces heat buildup that may occur between the skin and the pillow which further reduces sweating, swelling, and puffiness.

Modifications of the above described fabric arrangements are also possible for example, while overcoming the drawback of the prior art while also providing a fabric structure that some people may prefer, there is also disclosed a pillow and fabric structure that is comfortable for sleeping on. Such a fabric arrangement may include an outer fabric layer comprising materials such as cotton, flannel, linen, and similar fabrics while also incorporating slip layers to reduce or prevent wrinkles.

To create a fabric blend that helps eliminate wrinkles the fabric arrangement incorporates fabric layers with a low friction coefficient allowing the materials to slide past one another decreasing the build-up of shear stresses which cause wrinkles. As shown with the above embodiments, the fabric arrangement can be formed with a stretch material on the outer pillow case surface, and an interface formed with a second layer of material resulting in a low coefficient of friction between the layers. In this embodiment, anti-wrinkle properties are created even where the surface material does not have a significant ability to stretch, such as cotton and flannel.

To create anti-wrinkle properties with non-elastic outer materials as discussed herein, some embodiments include a blend of materials that allow the non-elastic material to slip on a lower surface material. In further embodiments, the fabric arrangement may comprise a single slip layer with two or more layers of bonded materials. In another embodiment, there may be three non-bonded layers in which at least two slip on each other.

Bonding may occur in any manner known in the art. The layers may be sewn at repeating intervals to establish the bond. Other bonding methods may also be used. Such methods include thermal bonding using a heat sealer, a large oven for curing, or calendaring through heated rollers (called spunbond when combined with spunlaid webs). Calendars can be smooth faced for an overall bond or patterned for a softer, more tear resistant bond. Also contemplated is hydro-entanglement using mechanical intertwining of fibers by water jets (which may be referred to as spunlace). Another bonding method is ultrasonic pattern bonding, or needle punching/needle felting using mechanical intertwining of fibers by needles. Yet another possible bonding method is chemical bonding (wet laid process) using binders (such as latex emulsion or solution polymers) to chemically join the fibers. A more expensive method uses binder fibers or powders that soften and melt to hold other non-melting fibers together. A melt blown process is also contemplated where a fiber is bonded as air attenuated fibers intertangle with themselves during simultaneous fiber and web formation.

Also contemplated are bonding nets that are precision engineered to give evenly sized and spaced adhesive dots, joined by thin polymer strands. Through control of the process, it is possible to form nets with a wide range of adhesive dot size, adhesive dot spacing, thicknesses, basis weight, hole size, hole shape, and open area. These nets may bond the fabrics.

The nets may be produced from HDPE (high density polyethylene) or PP (polypropylene) material. Nets are available as single layer materials or as two layer nets with an additional lower-temperature melting layer for bonding at higher speeds or for more delicate fabrics. Furthermore, the nets can be produced with a lower melting temperature fusible layer on one or both sides of the HDPE or PP “backbone.” A range of fusible layers are available, with different softening temperatures and flow characteristics to enable bonding to wide variety of substrates.

Using a two sided bonding net with a lower temperature fusible layer on one side gives the possibility of two-step bonding. The first bond is formed at a lower temperature, giving a net fused to the first substrate. A second substrate can then be bonded to the other surface of the net at a higher temperature.

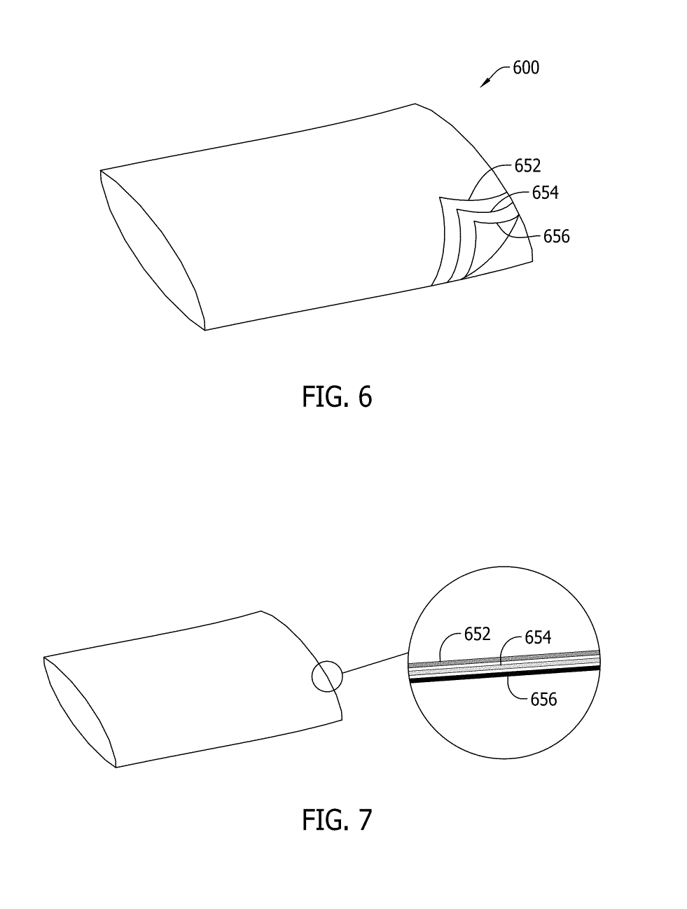

An example of one embodiment of an alternate fabric arrangement is shown in FIG. 6. In FIG. 6, a pillow case 600 is shown with multiple layers 652, 654, and 656. These layers may be on one side of the pillow case, or on both sides. An enlarged view of the layers in the fabric arrangement in shown in FIG. 7. In this embodiment, a top or outside layer 652 may be a cotton layer or other material on which a person is comfortable sleeping. The top layer 652 may thus have a top surface for contacting the skin of the user. The top layer 652 may comprise cotton, flannel, polyester, silk, or the like. The top layer 652 may be configured with some degree of stretchability while still being constructed from the preferable material on which a person would like to sleep.

The top layer 652 is bonded to a first slip layer 654. The first slip layer 654 is configured to have a low coefficient of friction with respect to a second slip layer 656. In this manner, the first slip layer 654 is configured to create slip in relation to the second slip layer 656. The slip layers 654, 656 may comprise silk, polyester, or any other similar material as described above to achieve a low coefficient of friction therebetween.

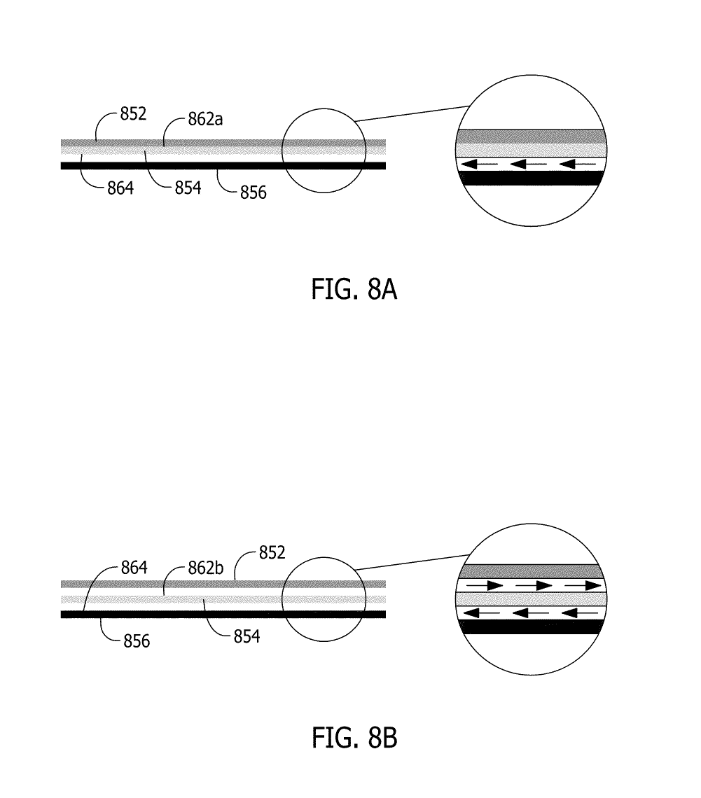

FIG. 8A and FIG. 8B illustrate a fabric arrangement with one or more spaces therebetween, according to exemplary embodiments. In the embodiment shown in FIG. 8A, the top or outside layer 852 is bonded to the first slip layer 854 at a bond 862a, such as one formed by one of the above-described bonding methods. The top layer 852 provides a desirable surface for the user, while the first slip layer 854 provides a low-friction surface to interface with the second slip layer 856. As shown in FIG. 8A, there is no bond between layers 854 and 856 so that the layers 854, 856 may slip against one another.

In another embodiment, a space 864 may be established between the first slip layer 854 and the second slip layer 856 to further reduce the friction between the layers 854, 856 and to provide a cooling channel that transfer heat or moisture away from the user. The space 864 may be filled with air or another fluid that maintains the separation between the layers 854, 856. The fluid may comprise any fluid including but not limited to water, or a chemical liquid mixture. In one embodiment, separator exists between the layers to maintain the gap, such as but not limited to, pillars, or air or liquid pressure in a sealed environment. The separation between layers may be maintained by pillars, supports, channels, or raised patterns of any shape between the layers.

The bonding of the materials in layers 852, 854 provides the benefit of a soft, user accepted outer layer with an opposing slip layer. As mentioned, the top layer materials are those that are favored by some people for a pillow case such as cotton, flannel, or even silk. To create the needed slip, a layer of lycra, polyesters or other material may be bonded to the top material. This bonding process may utilize glues, adhesive tapes and heat welding. Other bonding processes include sewing and thin layers of pre-sewn Velcro.

In FIG. 8B, instead of a bond connecting the top layer 852 to the first slip layer 854, a second space 862b may be provided between the layers. The second space 862b may serve to reduce the friction between the first and second layers 852, 854 while also providing an additional cooling channel to transfer heat or moisture away from the user.

Similar to the other embodiments described above, the fabric arrangement embodiment outlined with reference to FIGS. 6-8B also provides anti-wrinkle properties while giving a user a familiar and comfortable outer surface.

In another embodiment the fabric arrangement is configured as part of a sheet set, blanket, or a bottom sheet for beddings. The fabric arrangement could also be built into clothing, such as underwear, bras, gloves, undershirts, or socks to reduce wrinkles forming in skin and to reduce the sheer stress placed on skin when interacting with the fabric while also increasing comfort. The fabric arrangement could also be part of furniture or a furniture cover. It is contemplated that the fabric arrangement may be configured into any article which touches skin for an extended period of time.

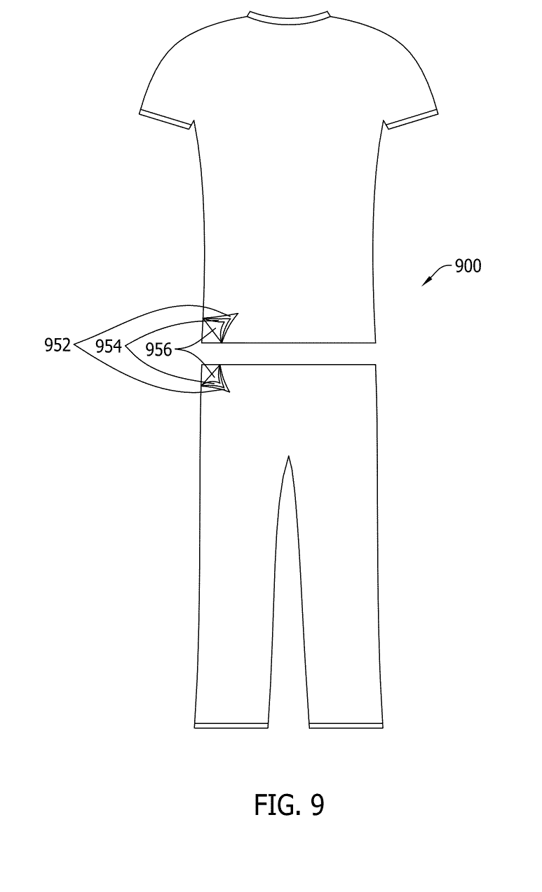

For example, FIG. 9 shows an exemplary fabric arrangement on an article of clothing. Here, a set of clothes 900 may be pajamas, a hospital gown, or other clothing. A fabric arrangement may be utilized on the clothes 900 to reduce wrinkles, to prevent bed sores, or to prevent damage to a surgical incision or other skin trauma. The clothes 900 may include an outer layer 952. The outer layer 952 may be stretchable or a conventional fabric as explained in the various fabric arrangement embodiments above. One or more slip layers 954 may be provided below the outer layers to facilitate low-friction between the outer layer 954 and the one or more slip layers 954. An inner layer 956 is also provided. The inner layer 956 may comprise an additional slip layer, and heat transfer layer, or the like as described above.

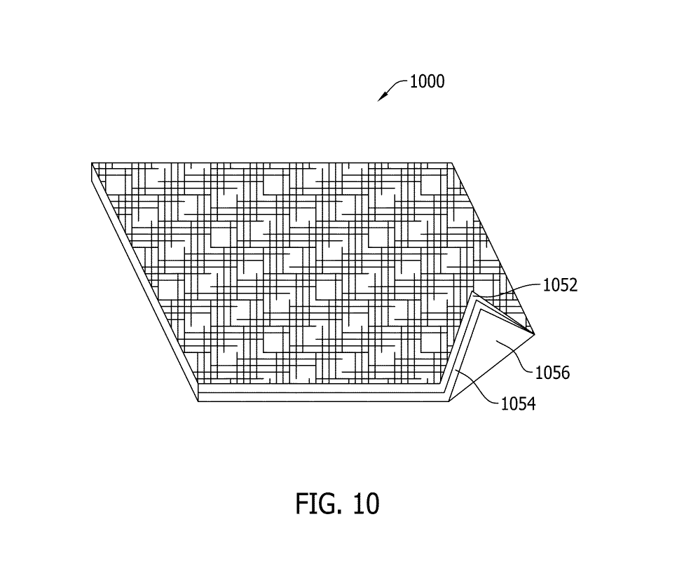

In another example, FIG. 10 illustrates an exemplary fabric arrangement in a medical wound care piece. The medical wound care piece 1000 thus comprises the layers of fabric 1052, 1054, and 1056 similar to the previously described fabric layers. In this manner, the medical wound care piece 1000 includes the injury preventing properties of the fabric arrangement when placed against the skin of a patient.

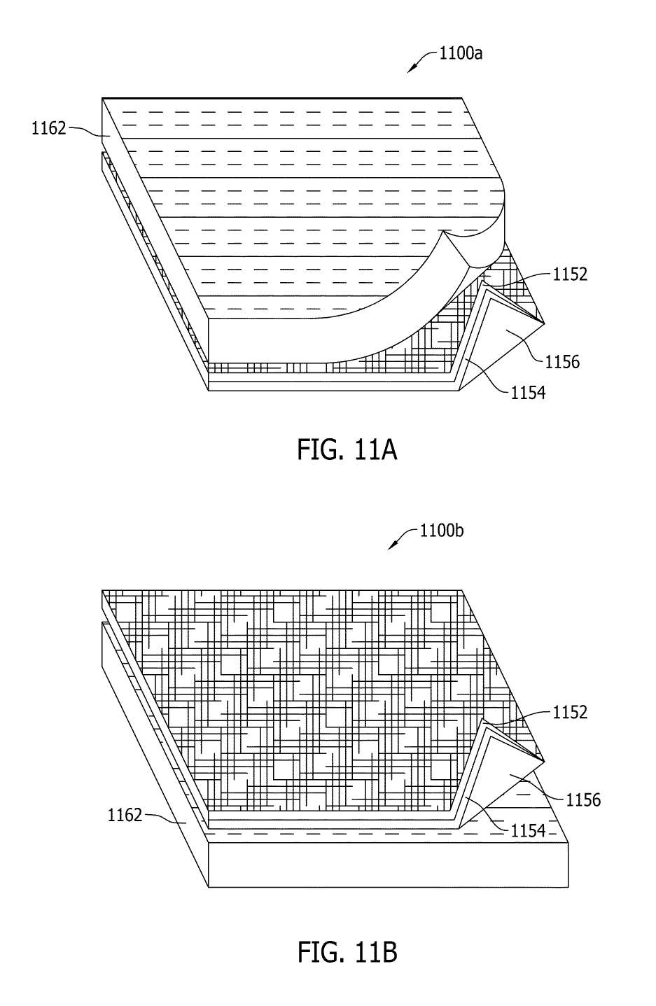

In yet another example, FIGS. 11A and 11B illustrate an exemplary fabric arrangement with an insulated material. Here, an insulated fabric arrangement 1100a, 1100b, includes layers 1152, 1154, and 1156 similar to the previously described fabric layers to provide the anti-wrinkle and injury preventing properties. The layers 1152, 1154, and 1156 may be placed on either side of an insulating liner 1162 depending on whether an inner or outer insulating lining is desired.

It is contemplated that in various embodiments the various layers described herein may be arranged in any order and in various embodiment different layers may be omitted and in embodiments having omitted layers, the included layers may be arranged in any order. In one embodiment the second layer does not stretch.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A fabric arrangement for an article that comes into contact with skin of a user, the fabric arrangement comprising:
a fabric panel comprising in order from a first layer coming into contact with the skin of the user:
a first skin contacting layer;
a second layer having a first side and a second side, the first side being bonded to the first layer, the second side comprising a low friction surface; and
a third layer comprising a low friction material, the third layer and the second layer joined at the edges and comprising the same general size, the third layer configured to slip against the second side of the second layer.

2. The fabric arrangement of claim 1, wherein the first skin contacting layer is comprised of at least one of cotton, polyester, flannel, and silk.

3. The fabric arrangement of claim 1, wherein the first skin contact layer is bonded to the first side of the second layer by at least one of thermal bonding, mechanical bonding, ultrasonic pattern bonding, and chemical bonding.

4. The fabric arrangement of claim 1, wherein the first skin contact layer is bonded to the first side of the second layer by a bonding net.

5. The fabric arrangement of claim 1, wherein the article comprises at least one of a pillow case, clothing, medical wound care piece, and insulated liner.

6. The fabric arrangement of claim 1, further comprising a space between the second layer and the third layer through which a fluid may pass.

7. A fabric arrangement for an article that comes into contact with skin of a user, the fabric arrangement comprising:
a fabric panel comprising in order from a first layer coming into contact with the skin of the user:
a first skin contacting layer comprising an elastic fabric;
a second layer having a first side and a second side, the first side adjacent the first skin contacting layer and comprising a low friction surface, the first layer and the second layer being joined at one or more point;
a third layer comprising a support layer configured to support the first layer and the second layer; and
a fourth layer comprising a cooling material configured to absorb head from the first layer, second layer, and third layer.

8. The fabric arrangement of claim 7, wherein the cooling material comprises one or more of sodium sulfate salt, sodium phosphate salt, sodium ammonium phosphate salt, or ammonium phosphate salt.

9. The fabric arrangement of claim 7, wherein the third layer comprises an antimicrobial element layer.

10. The fabric arrangement of claim 7, further comprising a scent pocket configured to hold a scent infused element.

11. The fabric arrangement of claim 7, wherein the third layer comprises foam.

12. A fabric arrangement for an article that comes into contact with skin of a user, the fabric arrangement comprising:
at least one panel comprising in order from a first layer coming into contact with the skin of the user:
a first layer comprising a fabric that is the skin contacting layer;
a second layer having a first side and a second side, the first side being adjacent to the first layer and comprising a low friction surface to establish low friction between the first layer and the first side of the second layer, and the first layer and the second layer being joined at one or more edges of either the first layer or the second layer.

13. The fabric arrangement of claim 12, further comprising a third layer adjacent the second side of the second layer, the third layer including a cooling material configured to absorb heat from the first layer and the second layer.

14. The fabric arrangement of claim 13, wherein the cooling material comprises one or more of the following materials from the group consisting of: sodium sulfate salt, sodium phosphate salt, sodium ammonium phosphate salt or ammonium phosphate salt.

15. The fabric arrangement of claim 12, further comprising a third layer, the third layer comprising a support layer or an antimicrobial element layer.

16. The fabric arrangement of claim 15 wherein the third layer comprises foam.

17. The fabric arrangement of claim 12, further comprising a scent pocket configured to hold a scent infused element.

18. The fabric arrangement of claim 12, wherein the elastic fabric is spandex.

19. The fabric arrangement of claim 12, wherein the elastic fabric is capable of stretching in any direction.

20. The fabric arrangement of claim 18, wherein the first layer is configured to not slip relative to the skin of the user, but instead to stretch with the skin of the user, and wherein the first layer slides relative to the second layer.
